(19) United States
(12) Patent Application Publication
(10) Pub. No.: US 2016/0027103 A1
(43) Pub. Date: Jan. 28, 2016

(54) AUTOMATIC DETERMINATION OF ELIGIBILITY, PAYMENTS AND TAX FOR MERCHANDISE USE

(71) Applicant: BillFloat, Inc., San Francisco, CA (US)

(72) Inventors: Driss Benamour, San Francisco, CA (US); Sean O'Malley, San Francisco, CA (US); Ryan Gilbert, San Francisco, CA (US); Chris Brown, San Francisco, CA (US); Neil Peretz, San Francisco, CA (US)

(21) Appl. No.: 14/339,089

(22) Filed: Jul. 23, 2014

(51) Int. Cl. G06Q 40/02; G06Q 30/06; G06Q 40/00

(52) U.S. Cl. CPC G06Q 40/02; G06Q 30/0645; G06Q 40/10

(57) ABSTRACT

A system for automatic determination of eligibility, payments and tax for a merchandise lease comprises an interface and a processor. The interface is configured to receive a minimal set of information. The processor is configured to determine that it is possible to determine a full identity using the minimal set of information; determine a maximum lease amount based at least in part on the full identity; and determine one or more lease payments and lease tax based at least in part on a merchandise price and a location tax rate.

### BACKGROUND OF THE INVENTION

Outright purchase of a piece of equipment is the most straightforward way to be able to use the piece of equipment when and where a user desires. In some cases though, the user is not able to purchase the piece of equipment either for cash or using available personal credit (e.g., a credit line or credit card).

### BRIEF DESCRIPTION OF THE DRAWINGS

Various embodiments of the invention are disclosed in the following detailed description and the accompanying drawings.

FIG. 1 is a flow diagram illustrating an embodiment of a process for a system for automatic determination of payments and tax for merchandise use.

FIG. 2 is a flow diagram illustrating an embodiment of a process for a system for automatic determination of payments and tax for merchandise use.

FIG. 3 is a flow diagram illustrating an embodiment of a process or shopping in a store.

FIG. 4 is a flow diagram illustrating an embodiment of a process for initiating the lease.

FIG. 5 is a flow diagram illustrating a process for securing consent for a lease agreement.

FIG. 6 is a flow diagram illustrating an embodiment of a process for on-line leasing of merchandise.

FIG. 7 is a flow diagram illustrating an embodiment of a process for on-line leasing of merchandise.

FIGS. 8A, 8B, and 8C are flow diagrams illustrating embodiments of a process for a return of merchandise that has been leased.

FIG. 9 is a diagram illustrating an embodiment of a mobile device display of a system for calculating payments.

FIG. 10 is a diagram illustrating an embodiment of a mobile device display of a system for calculating payments.

FIG. 11 is a diagram illustrating an embodiment of a mobile device display of a system for calculating payments.

FIG. 12 is a diagram illustrating an embodiment of a mobile device display of a system for calculating payments.

FIG. 13 is a diagram illustrating an embodiment of a mobile device display of a system for calculating payments.

FIG. 14 is a diagram illustrating an embodiment of a mobile device display of a system for calculating payments.

FIGS. 15A and 15B are diagrams illustrating an embodiment of a mobile device display of a system for calculating payments.

FIG. 16 is a diagram illustrating an embodiment of a mobile device display of a system for calculating payments.

FIGS. 17A, 17B, 17C, and 17D are diagrams illustrating an embodiment of a mobile device display of a system for calculating payments.

FIG. 18 is a diagram illustrating an embodiment of a mobile device display of a system for calculating payments.

FIG. 19 is a diagram illustrating an embodiment of a mobile device display of a system for calculating payments.

FIG. 20 is a diagram illustrating an embodiment of a mobile device display of a system for calculating payments.

FIG. 21 is a diagram illustrating an embodiment of a mobile device display of a system for calculating payments.

FIG. 22 is a block diagram illustrating an embodiment of a system for calculating payments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A system for determination of eligibility, payments and tax for merchandise use is disclosed. The system comprises an interface and a processor. The interface is configured to receive a minimal set of information. The processor is configured to determine that it is possible to determine a full identity using the minimal set of information; determine a maximum lease amount based at least in part on the full identity; and determine one or more lease payments and lease tax based at least in part on a merchandise price and a location tax rate.

In some embodiments, a system for determination of eligibility, payments and tax for merchandise use is disclosed. In various embodiments, the legal relationship providing for the use of the merchandise comprises leasing the merchandise, renting the merchandise, lease-to-own, rent-to-own, or financing the purchase of the merchandise in conjunction with taking a lien on or purchase money security interest in the merchandise to secure repayment. In the description below, merchandise use is discussed in the context of leasing. However, it should be obvious to someone familiar in the art that other collateralized merchandise arrangements are equally appropriate for the described system. For example, the user is described herein as a lessee, however the user may also be referred to as the renter or borrower, while the entity referred to herein as the lessor may also be referred to as the lender in some legal relationships.

In some embodiments of the system for determination of eligibility, payments and tax for merchandise use, the system enables a user to enter a minimal amount of information and automatically determines whether it is possible to determine a full identity. For example, from a minimal amount of information (e.g., a full name, a date of birth, a last 4 digits of the social security number, etc.), a full identity is determined including, for example, the entire social security number, address information, etc. In the event that it is possible to determine a full identity, the identity is verified and an amount is automatically determined for leasing. The automatic determination for leasing is based at least in part on a full identity of the prospective lessee and the information that is determined based on the full identity. For example, financial information (e.g., credit score, banking information, etc.), which in turn is used for automatically determining a maximum value of equipment that a user can lease. In some embodiments, a secured mechanism other than leasing is used—for example, lease-to-own, rent-to-own, credit, factoring of merchandise purchases, or any other appropriate mechanism. This maximum lease amount is provided to the user while shopping on-line or in a brick and mortar store. The user provides an identifier (e.g., a serial number, an item description, a universal product code (UPC), etc.) for the equipment or merchandise. This information is used to determine exact equipment or merchandise to be leased and its description and/or key characteristics. The place of purchase is determined (e.g., using the geolocation of a mobile device that the user is using in the brick and mortar store or from the location of the on-line store (e.g., a physical or legal location associated with the on-line store) or its effective location (e.g., a user shipping address). In some embodiments, in the event that geolocation is not determined automatically from a mobile device, the user is requested to provide a zip code to determine the place of purchase. The place of purchase location is used for determining the state and tax rate for the purchase, for determining a localized cost of repossessing the merchandise in the future, local theft and loss rates for similar merchandise, and for searching and cross-referencing local and regional resale values to automatically determine a more precise collateral value. The total amount of a purchase is received (e.g., from the consumer or user) and from that the merchandise price is calculated by subtracting a tax amount (e.g., as derived using the tax rate previously determined) from the total amount of purchase. The price and tax are automatically separated to enable a user to only enter the total amount of the purchase price for ease of use—for example, the user enters only the total price and the system, using the determined tax rate for that location, calculates the merchandise price and the tax that make up the total price. In some embodiments, accurate merchandise depreciation schedules are determined using the determined pre-tax merchandise price thus making the depreciation calculation independent of the tax rate. The merchandise price and tax along with the location information are used along with the data such as the collateral value and depreciation rate of the leased items to automatically determine a lease payment amount, number of payments, and tax for the lease payments as well as an initial lease payment amount. These terms of the proposed lease are provided to the user to enable the user to decide whether to accept the lease offer, to agree to the lease, and to provide the initial lease payment. The initial payment is received using a transaction (e.g., using a debit card, a direct bank transfer, etc.). The on-line or brick and mortar store is provided with a virtual payment card chargeable to the lessor to purchase the merchandise (e.g., a synthesized or virtual payment card that is funded for the merchandise total cost). The virtual payment card remains active only until a pre-determined return time period is expired so that a return of the merchandise and refund of the purchase price to the account from which the virtual payment card was issued can be affected. In the event of a partial return, the lease terms (e.g., payment amount, payment number, tax amount, etc.) are automatically recalculated.

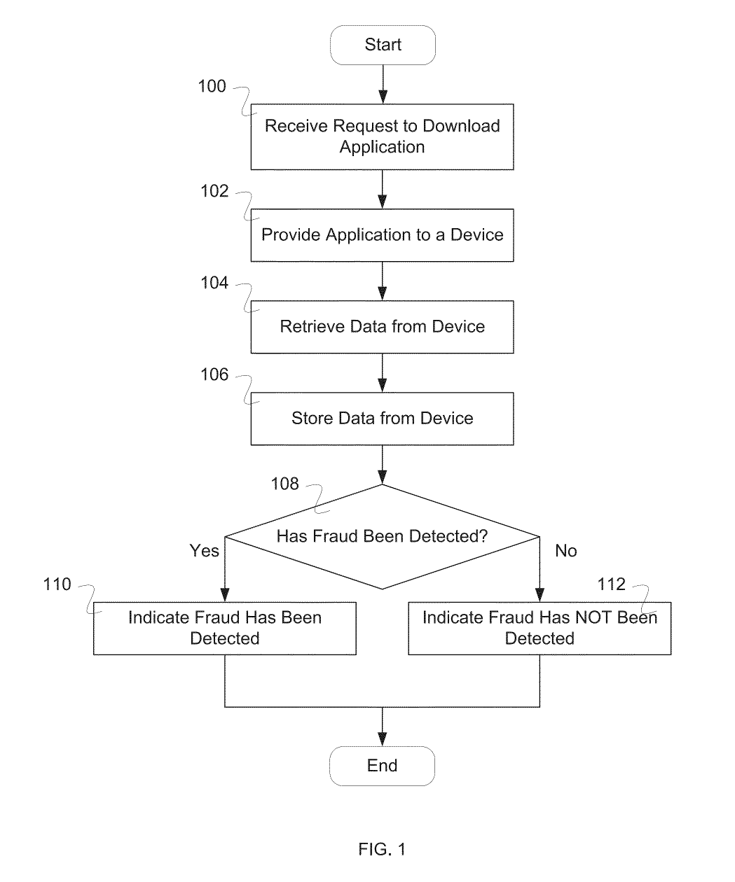

FIG. 1 is a flow diagram illustrating an embodiment of a process for a system for automatic determination of payments and tax for merchandise use. In the example shown, in 100 a request is received to download an application. In 102, an application is provided to a device. In 104, data is retrieved from the device. For example, data retrieved from the device includes a unique serial number, an IP address, the identity of the telephone or cellular network provider, a network, a carrier, a phone model, a device model, a number of applications installed on the device, the type of applications installed on the device, a telephone number assigned to the device, an email address associated with the device, locations where a user uses the system, a first name, and/or a last name. In some embodiments, consent of the user is obtained on installation of an application on the mobile device. In 106, data is stored from the device. In 108, it is determined whether fraud has been detected. For example, determining whether fraud is detected uses the data retrieved from the device and other databases. In some embodiments, a 3^{rd} party vendor is used to assess fraud. In some embodiments, fraud is determined by using machine learning techniques to determine indicators of fraudulent behavior. For example, if multiple applications coming from the same device under different applicant names are detected in a given period of time, that may be an indicator of fraud. In some embodiments, if usage of similar information is detected (e.g., exact same password is being used repeatedly in a given timeframe) across multiple devices or widely distant locations, that may be an indicator of fraud. In the event that fraud has been detected, in 110 it is indicated that fraud has been detected. In the event that fraud has not been detected, in 112 it is indicated that fraud has not been detected.

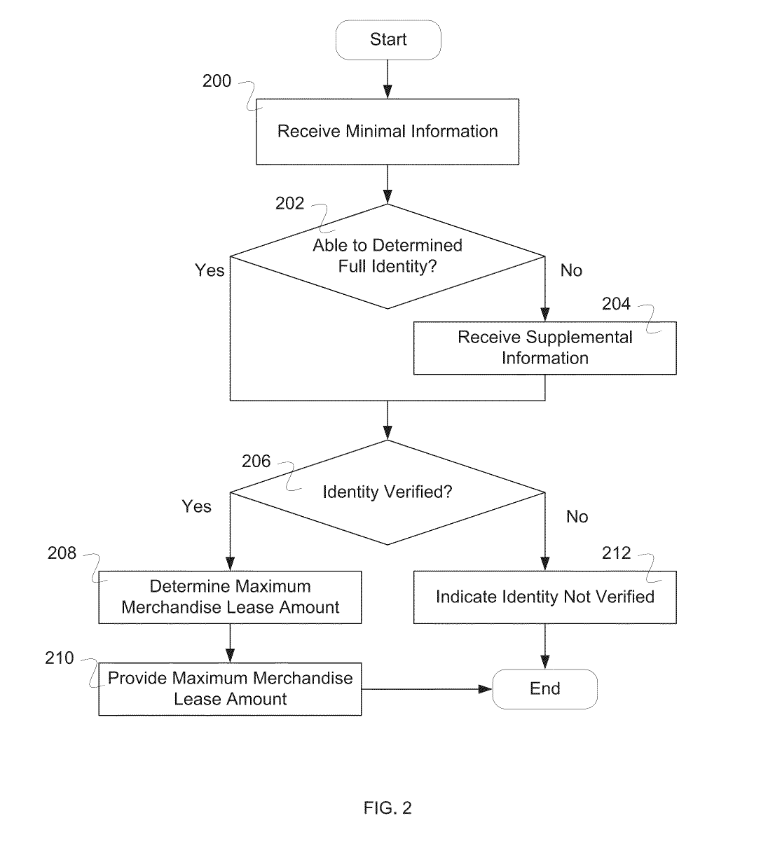

FIG. 2 is a flow diagram illustrating an embodiment of a process for a system for automatic determination of payments and tax for merchandise use. In the example shown, in 200 minimal information is received. For example, the minimal information comprises a name, a date of birth, and a last four digits of a social security number or username and password associated with a user. In some embodiments, cross-referencing data from a third party vendor (e.g., a user reporting agency, credit bureau, or an identity verification service provider—for example, Experian, IDology, IDAnalytics, Equifax, etc.) is used to determine or validate a full identity from the minimal information. In 202, it is determined whether a full identity is able to be determined. For example, it is determined whether a full identity is able to be determined, validated, or reconstructed based on the minimal information provided. In some embodiments, data about the user's mobile device and its location is used to help distinguish among user identities by cross-referencing the user's home and work addresses and type of mobile device used. In the event a full identity is not able to be determined, in 204 supplemental information is requested from User and received and control passes to 206. For example, a full address and/or a full social security number is/are received. In the event a full identity is able to be determined, control passes to 206. In 206, it is determined whether the identity is verified. For example, identity is verified using a 3^{rd} party database (e.g., IDanalytics or IDology), by verifying the user's phone number (e.g., by sending a message—for example, an short message service message (SMS)—to the phone provided by the user and intercepting the SMS or having the user enter a code provided in that SMS, or by allowing the user to scan their identity credential using the phone camera or magnetic reader. In the event that the identity is verified, in 208 a maximum merchandise lease amount is determined. For example, a credit decision is made based at least in part on the full identity information, which includes name, address, date of birth and social security number. In 210, a maximum merchandise lease amount is provided. For example, a user is able to view the maximum lease amount (e.g., as displayed in an application on a device) and proposed lease terms, such as lease duration, and can proceed to lease merchandise valued up to the maximum lease amount. In some embodiments, a user enters a payment method to speed up a checkout process later and to verify the user's identity by requesting authorization for charges utilizing the payment method and components of the user's identity (e.g., the user's address). In the event that the identity is not verified, in 212 it is indicated that the identity is not verified. In some embodiments, the progressive identity verification of the process enables maximizing approval rates while minimizing data entry for a majority of users.

In some embodiments, data retrieved from the device is as input to determining the maximum lease amount. For example, 1) the types of applications installed are analyzed to predict risk of the user's ability to make responsible on-time payments; 2) the presence of a banking application that matches the user's debit card bank is used to confirm accuracy of information; 3) the device type and price is used to determine a user's income level; 4) the user's physical location is used to determine risk (e.g., locations traveled to); 5) the age of the device is used to determine risk; and 6) email history, messaging history, browsing history, cloud based document storage applications are examined to determine risk (e.g., after permission is received from a user to access).

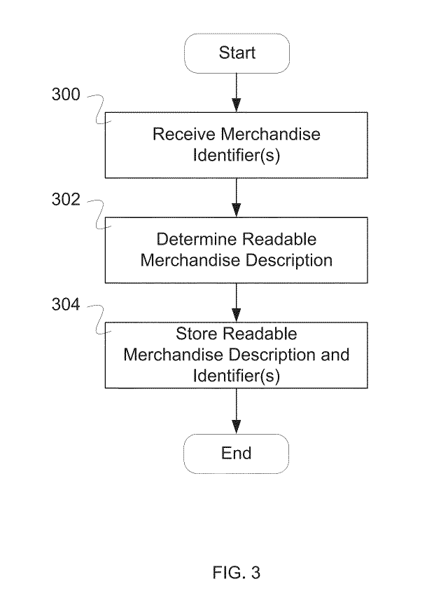

FIG. 3 is a flow diagram illustrating an embodiment of a process or shopping in a store or on-line. In some embodiments, a user walks into any retail store to shop or was already in a retail store, and shops and selects desired merchandise in-store. The identity and location of the store can be determined using the internet protocol (IP) address of the store WiFi network, the Bluetooth Low Energy (BTLE) signal being broadcast in the store, or the global positioning system (GPS) coordinates of the device when it is in the store. In some embodiments, the use of location technology is used to identify the location of the merchandise within the store. In some embodiments, the user is shopping on-line. In the example shown, in 300 merchandise identifier(s) is/are received. For example, a user scans merchandise barcodes using a mobile device camera. The barcode is read (e.g., using image processing technology) and a merchandise universal product code (UPC) and/or a unique serial number is/are determined from the barcode. For example, a user takes a picture of a piece of merchandise and the identity of the merchandise is determined by comparing the picture to a database of product pictures. Alternatively, the user types in the merchandise description or serial number and suggested merchandise is presented for the user to select using natural language processing techniques. In 302, a readable merchandise description is determined. For example, the UPC is used to look up a merchandise description in a database. In 304, a readable merchandise description and identifier(s) are stored. For example, the description and identifier(s) (e.g., the UPC, and the serial number) are stored to be used to enable the inclusion of a clear description of the merchandise in a lease agreement between the user or user and the system for providing a lease and to assess the resale value of and general user satisfaction with the merchandise and use that information when underwriting the terms of the lease. For example, if the merchandise to be leased has a lower user satisfaction level, as determined by searches of external databases and review books and websites, the term of the lease could be automatically shortened so the lease more closely matches the time period that the user will want to use the merchandise. For example, in the event that the merchandise to be leased has a higher reported rate of breakdowns and repairs, as determined by searches of external databases and review books and websites, the term of the lease could be automatically shortened so the lease more closely matches the projected useful life of the merchandise. For example, in the event that the resale value of the merchandise to be leased has a longer life than other products in the same category of merchandise, as determined by searches of external databases and review books and websites, the term of the lease could be automatically lengthened so the lease more closely matches the projected useful life of the merchandise.

In some embodiments, merchandise descriptions and/or identifiers are entered manually by a user. In some embodiments, merchandise descriptions and/or identifiers are recognized using image recognition processing to compare the image to images of merchandise in databases. In some embodiments, suggestions are made to enable more accurate descriptions and/or identifiers. In some embodiments, suggestions are made using a suggestion database. In some embodiments, the store location and merchandise location within the store are used to help identify the merchandise.

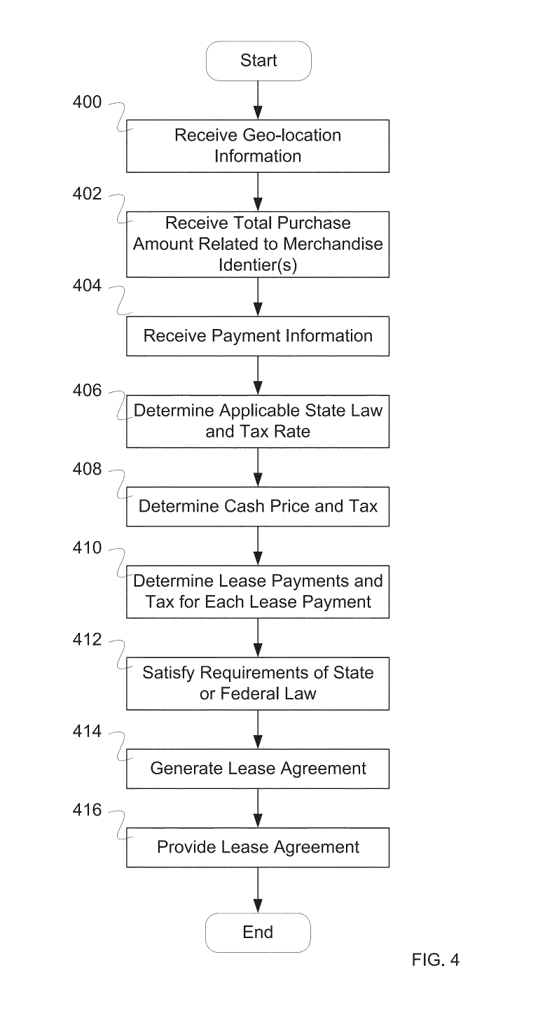

FIG. 4 is a flow diagram illustrating an embodiment of a process for initiating the lease. In the example shown, in 400 geolocation information is received. For example, a user's or user's device's physical location is determined. In various embodiments, the location is determined using a global positioning system (GPS), a cellular tower location, a cellular tower triangulation, a WiFi transceiver location, bluetooth beacon location, computer vision recognition of surroundings, dead reckoning measurement from a known fixed point, or any other appropriate location determination.

In 402, a total purchase amount related to the merchandise identifier(s) is received. For example, at checkout a user receives the total purchase price of the merchandise that user desires to lease. The total purchase price includes the tax cost and the cost of the merchandise associated with the merchandise identifier(s) and this price is entered into the application on the mobile device or this price may be looked up on an external website or database for the retailer where the merchandise is located.

In 404, payment information is received. For example, a payment method (e.g., a debit card number) is received to enable a first payment associated with a lease agreement. In some embodiments, payment information is received earlier during the application portion of the process.

In some embodiments, lease payment date frequency is edited. For example, a user is enabled via a graphical user interface to change a payment date frequency (e.g., once a month, once every two weeks, once a week, etc.).

In 406, applicable state law and tax rate are determined. For example, the geolocation is converted to an address allowing applicable local and state law and a tax rate to be determined.

In 408, a cash price and tax is determined. For example, a price for merchandise is determined by subtracting the tax using the applicable tax rate from the total purchase price. This calculation is performed to improve convenience and usability by a user so that only one total purchase amount needs to be received for the lease merchandise. The user does not have to enter multiple prices or the store's tax rate. For example, the user simply enters the total purchase amount as indicated by the store clerk or cashier: this reduces friction.

In 410, lease payments and tax for each lease payment are determined. For example, based on the cash price for the merchandise lease payments and tax payments are determined for one or more lease payments.

In 412, requirements of state or federal law are satisfied. For example, disclosures of same as cash options, early lease payoff, total lease cost, renewal period prior to obtaining ownership of the merchandise, payment terms, promotion terms, and late fee schedules are made as required by applicable state or federal law.

In 414, a lease agreement is generated. For example, using the merchandise information and identifier(s) as well as the applicable state and tax information, a lease agreement is automatically generated in compliance with state or federal law. In some embodiments, the automatic generation of the lease agreement includes language and disclosures—for example, item description, condition of property, lease payment, lease tax, processing fee, rental period, total of payments, risk of loss and damages, early purchase amount at various points in time, early purchase description in agreement, etc.

In 416, the lease agreement is provided. For example, the lease agreement is provided to a user (e.g., being displayed on user device display). In some embodiments, the user is enabled to access the agreement within the mobile application at any time.

For example, from the total purchase amount=$1082.50, tax rate based on location determined through geolocation=8.25%, the system determines: cash price=$1082.50 less the $82.50 tax=$1000, for a lease term of 24 months, a monthly lease payment of $55, a monthly lease tax of $4.54, total monthly payment of $50.54, and same as cash period of 90 days based on the state law where the transaction is occurring.

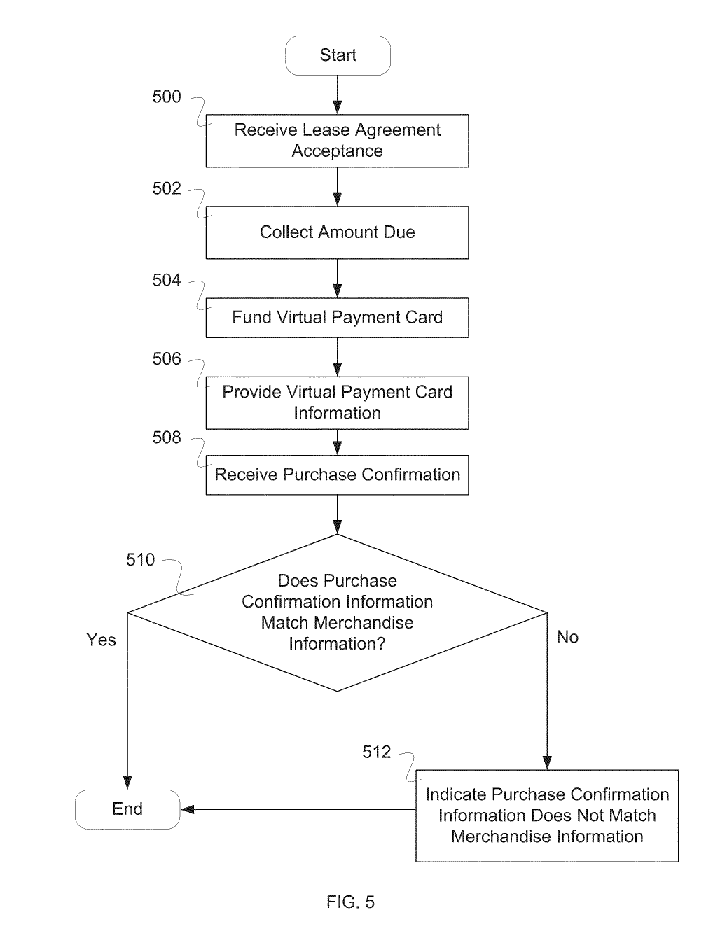

FIG. 5 is a flow diagram illustrating a process for securing consent for a lease agreement. In the example shown, in 500 a lease agreement acceptance is received. For example, a user signs the agreement electronically and the system receives and stores the electronic signature (e.g., e-signature and/or associated hash—for example, a cryptographic hash). In 502, an amount due is collected. For example, an amount for a lease payment and/or application fee due today is collected from the user using a user payment method (e.g., a debit card, an electronic account transfer, etc.). In 504, a virtual payment card is funded. For example, the virtual payment card payable by the lessor is authorized for the total purchase amount (e.g., the merchandise price and tax). In 506, virtual payment card information is provided. For example, the virtual payment card information is provided to a display on a user's mobile device display. Or, for example, the virtual payment card information is provided directly to the retailer selling the merchandise to lessor. In 508, a purchase confirmation is received. For example, a lessor system provides to the user a confirmation of the purchase of the merchandise that is received from the merchant system or from the user device. In 510, it is determined whether purchase information matches merchandise information. For example, the lessor system compares the purchase information it receives with the merchandise information of the lease and merchandise information captured by the user's device. In the event that the purchase information matches the merchandise information, the process ends. In the event that the purchase information does not match the purchase merchandise information, in 512 it is indicated that purchase confirmation information does not match merchandise information and the process ends or the user is asked to rectify the discrepancy and complete the process. In the event that the virtual payment card is reported as being used at a location that is different from the location of the device, a fraud indication is triggered and the transaction may be declined. For example, payment from lessor to the retailer using the virtual payment card is declined in real-time.

In some embodiments, the virtual payment card information is used for the purchase of the merchandise (e.g., the retail clerk enters the virtual payment card information as part of the purchase process or the virtual payment card information is scanned from the mobile device display or a copy of the virtual payment card is printed). In some embodiments, purchase information comprises a photo of a transaction receipt and location information about the purchase transaction gathered by the device.

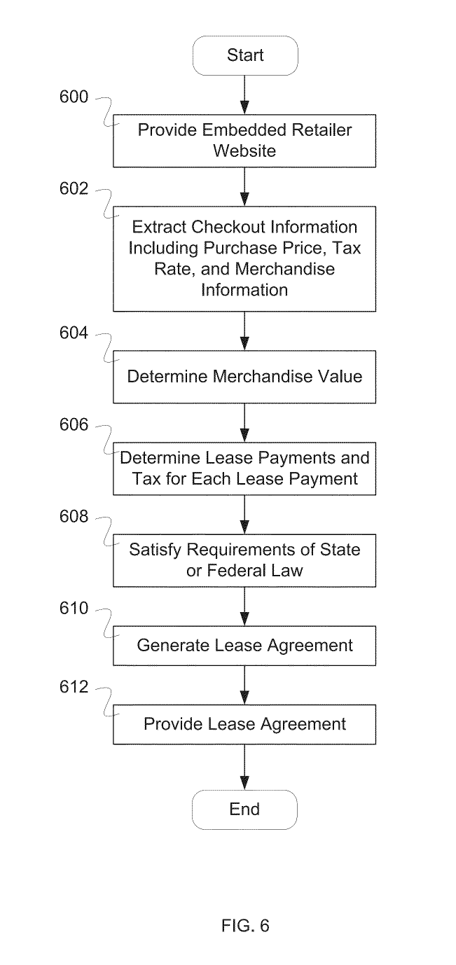

FIG. 6 is a flow diagram illustrating an embodiment of a process for on-line leasing of merchandise. In the example shown, in 600 an embedded retailer website is provided. For example, a user shops on a retailer's website in a webview embedded within an application (e.g., a mobile application, a desktop application, etc.). The application is able to monitor the interactions that the user has with the embedded retailer's website. In 602, checkout information is extracted including purchase price, tax rate, location information, and merchandise information. For example a user uses the device to select merchandise on a retailer's website or log into the user's account with the on-line retailer and arranges the purchase of merchandise (e.g., for selected items in a cart). The application extracts purchase price, tax rate, and merchandise information (e.g., description, stock keeping unit (SKU) identifier, identification numbers, serial numbers, etc.) from the retailer's display page(s) (e.g., using screen scraping or web scraping techniques) or using application programming interfaces (APIs) to connect to the retailer. In some embodiments, the user is presented with an offer for similar or complementary merchandise or services, along with an incentive to lease the other merchandise instead—for example, the item that is to be leased is determined and instead an offer or promotion is made for a different piece of available merchandise at the same retailer (e.g., before you lease the ‘XX’ phone, consider the ‘YY’ phone and the ‘YY’ company will make your first lease payment for you!”). For example, the user purchasing a cellular telephone may be offered cellular telephone service. In 604, merchandise value is determined. For example, the merchandise price, tax, delivery and handling charges are determined (e.g., from the total purchase amount=$1082.50, tax rate based on location determined through geolocation=8.25%, the system determines: cash price=$1082.50 less the $82.50 tax=$1000, for a lease term of 24 months, a monthly lease payment of $55, a monthly lease tax of $4.54, total monthly payment of $50.54, and same as cash period of 90 days based on the state law where the transaction is occurring). In 606, lease payments and tax for each lease payment are determined. For example, the system uses information gathered about the user, the purchase (e.g., the purchase amount), and/or the merchandise to compute and display financing terms (e.g., monthly lease payment) to the user in the context of a web-based shopping experience. In some embodiments, the resale value, useful life, and customer satisfaction scores for the merchandise are checked automatically and used in the determination of leasing terms. In 608, disclosure requirements of state or federal law are satisfied. For example, after using the location of the device and retailer to determine which state and local law applies, disclosures are provided to the user based on state or federal law requirements. In various embodiments, the state is determined from information provided by the user, from information from the web-site (e.g., stored information associated with the user, account information accessed via an API, etc.), website business location(s), or any other appropriate information sources. In 610, a lease agreement is generated. For example, a lease agreement is generated automatically with information regarding the merchandise to lease that satisfies state and federal requirements. In 612, a lease agreement is provided. For example, the user is presented with the lease agreement in order that the user can agree by providing a signature.

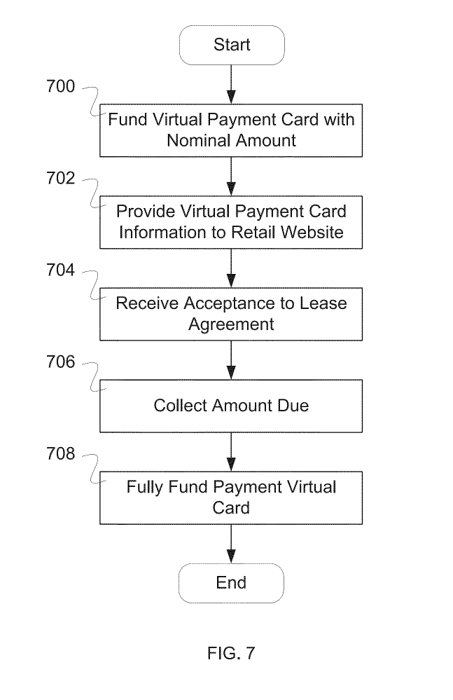

FIG. 7 is a flow diagram illustrating an embodiment of a process for on-line leasing of merchandise. In the example shown, in 700 a virtual payment card is funded with a nominal amount. For example, the virtual payment card is generated with a nominal amount (e.g., $1) so that a user can enter the payment method prior to finding out the final purchase amount. In 702, virtual payment card information is provided to a retail website. For example, the system automatically populates virtual payment card information (e.g., card number, associated card name, card expiration date, card security code, etc.) into the retail website fields. In 704, acceptance to a lease agreement is received. For example, a user electronically agrees to the lease agreement (e.g., using an electronic signature) and the acceptance to the lease agreement is received by the system from the user. In 706, an amount is collected. For example, an initial amount due on the lease, which may include an application fee, is collected, by the lessor, using a debit card from the user or using a bank transfer from the user's account. In some embodiments, there is no initial amount due for the lease. In 708, the virtual payment card is fully funded. For example, the system automatically funds the virtual payment card with the purchase amount to simultaneously (i) finalize the payment to the retailer by the lessor or secured lender for the merchandise, which will be paid via virtual payment card presented by the user or provided directly to the retailer, and (ii) finalize the lease transaction between the lessor and the user. In some embodiments, the previously generated virtual payment card is funded with the purchase amount for the merchandise and the later lease payments are calculated for the purchase amount less the initial amount due. In some embodiments, the later lease payments are calculated using the lease term (e.g., the number of months), the number of payments over the term (e.g., monthly), the expected resale value and useful life of the merchandise to be leased, the location of the merchandise and the user, and the associated lease tax and lease fees. In some embodiments, a virtual payment card is created and funded using a call to an application programming interface to a third party provider.

In some embodiments, in the event that the item(s) is/are desired to be completely returned within the merchant return window, a full refund is issued to the consumer for the portion of the initial lease payment paid corresponding to the returned items and the user is required to return the item(s) to the merchant. The merchant credits back the full merchandise value into the lessor's virtual payment card. The ability to secure a full refund may not be available to the consumer under the terms of the lease, however the lessor may provide similar terms to the merchant's return policy if the merchant will accept a return of the leased merchandise. For example, a lease amount including tax is $1082.50, the first payment is $59.54, the item is returned to the merchant within the return period, the merchant credits the virtual payment card the $1082.50, the first payment of $59.54 is refunded to the user's payment method, and the lease is cancelled.

In some embodiments, in the event that the item(s) is/are desired to be completely returned but not within the merchant return window, no refund is provided for past payments on the lease, the lease is cancelled, and the user is required to return the item(s) to the lessor.

In some embodiments, in the event that a partial return of items is desired within the merchant return window, a partial refund is issued for the portion of the upfront payment paid corresponding to the returned items and the user is required to return the item(s) to the merchant. The refund is not required in the case of a lease, but can be offered to honor the merchant's return policy. For example, a lease amount including tax is $1082.50, the first payment is $59.54, the item is returned to the merchant within the return period, the merchant credits the virtual payment card the $541.25, a portion of the first payment of $59.54 is refunded to the user's payment method (e.g., $30.31) and the lease is adjusted so that monthly payments are now $29.23 and the Lease agreement and all legal disclosures/calculations are also adjusted. In some embodiments, the user is prompted to agree to new adjusted lease agreement where applicable.

In some embodiments, in the event that the item(s) is/are desired to be partially returned but not within the merchant return window, no refund is provided for past payments on the lease, the lease is adjusted, and the user is required to return the item(s) to the lessor.

In various embodiments, in the event that the merchandise is returned to lessor, then the trigger to change the lease comprises one or more of the following: tracking info from a shipping company, notice of receipt of the item from the receiving department of the company or its warehousing contractor, an indication from the merchant of return, or any other appropriate indication to change the lease.

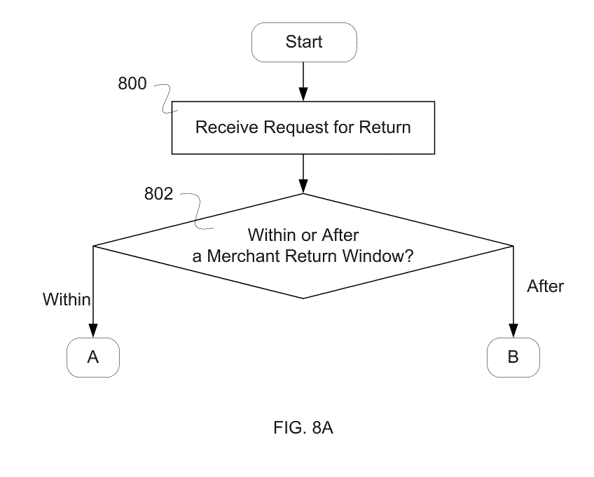

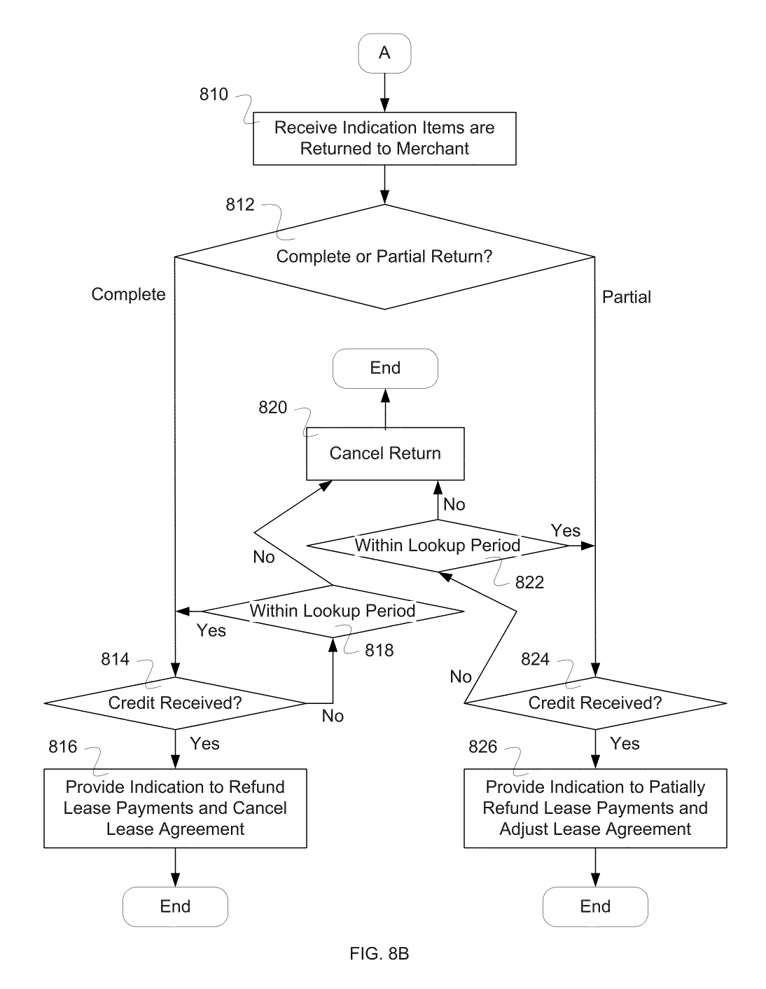

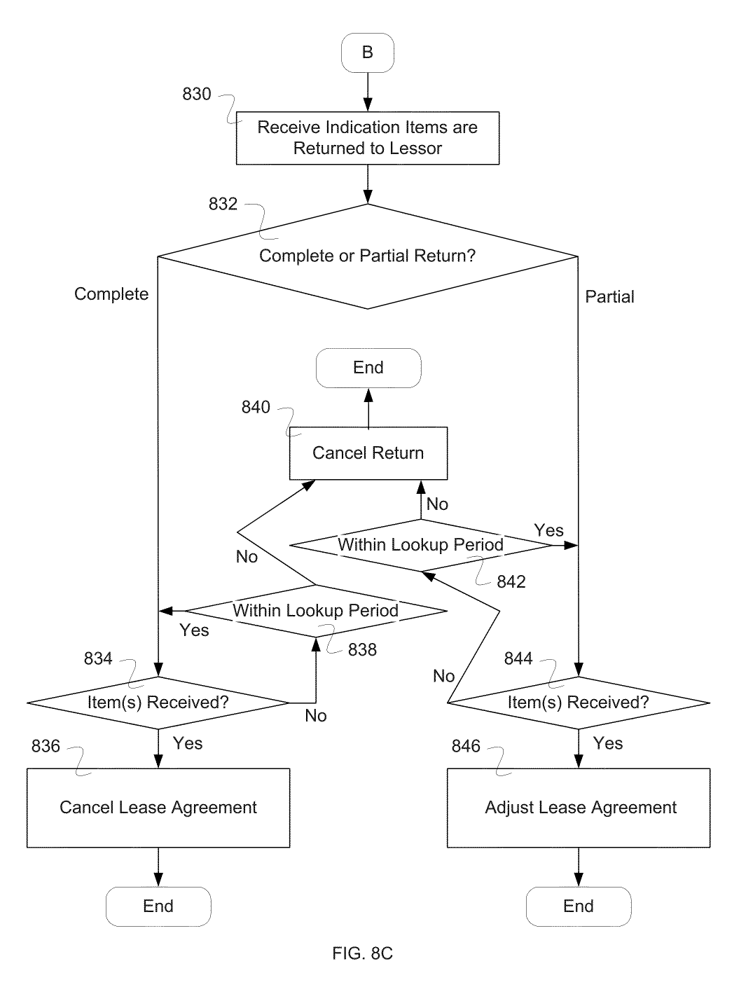

FIGS. 8A, 8B, and 8C are flow diagrams illustrating embodiments of a process for a return of merchandise that has been leased. In the example shown in FIG. 8A, in 800 a request is received for return. For example, a request is received from user on an application (e.g., a mobile application) that a lease item is to be returned. The location of the device is used to predict the location of the merchandise to be returned. The location of the merchandise is used to determine the shipping or dropoff address to which the returned merchandise should be sent or brought and any shipping service to be used. In 802, it is determined whether the return is within or after a merchant return window. In the event that the return is within the merchant window, control passes to A. In the event that the return is after the merchant window, control passes to B.

In the example shown in FIG. 8B, in 810 an indication is receive that items are returned to merchant. In 812, it is determined whether the return is a complete or partial return. For example, it is determined whether the item(s) desired to be returned represent the entire set of leased items or a subset thereof. In the event that it is determined that the return is a complete return, control passes to 814. In 814 it is determined whether a credit has been received. For example, a credit is received for the returned total amount including tax, and the previously determined tax rate is used to determine the return value (e.g., the total amount less the tax). For example, the system monitors the virtual payment card account balance for a credit. In some embodiments, the system checks the virtual payment card balance periodically (e.g., every 15 minutes) until the credit appears in the account balance. In the event that the credit has been received, in 816 an indication is provided to refund lease payments and the lease agreement is canceled. In the event that the credit has not been received, in 818 it is determined whether it is within a lookup period. In the event that it is within the lookup period control returns to 814. In the event that it is not within the lookup period, in 820 the return is canceled.

In the example shown in FIG. 8B, in the event that it is determined that the return is a partial return, in 824 it is determined whether a credit has been received. For example, the system monitors the virtual payment card account balance for a credit. In some embodiments, the system checks the virtual payment card balance periodically (e.g., every 15 minutes) until the credit appears in the account balance. In the event that a credit has been received, in 826 an indication is provided to partially refund lease payment(s) and adjust the lease agreement. In some embodiments, the lease is adjusted (e.g., the monthly lease payment, lease tax, lease fees, description of the items being leased, are recalculated, etc.), the lease agreement is updated automatically; a partial refund of the upfront amount is provided to the user's payment method. In some embodiments, in order to process a partial return, the user is required to agree to an updated lease agreement. In some embodiments, the amount credited by the retailer to the virtual payment card is not the same as entered by the user when processing the return (e.g., it is less a restocking fee); the system automatically adjusts the lease and the refund amounts based on the actual amount credited to the virtual card and the user is notified. In the event that the credit has not been received, in 822 it is determined whether it is within a lookup period. In the event that it is within a lookup period, then control passes to 824. In the event that it is not within a lookup period, then in 820 the return is canceled. In some embodiments, in the event that a payment is not received for a predetermined time (e.g., 48 hours), the return is terminated and the lease stays in place.

In the example shown in FIG. 8C, in 830 an indication is receive that items are returned to lessor. In 832, it is determined whether the return is a complete or partial return. For example, it is determined whether the item(s) desired to be returned represent the entire set of leased items or a subset thereof. In the event that it is determined that the return is a complete return, control passes to 834. In 834 it is determined whether the item(s) has/have been received. For example, a list of the returned items is received. In some embodiments, the items received are checked to determine whether the items received are in good condition before canceling/adjusting the lease. In the event that the items are not in good conditions, then the consumer is liable for the fair market value of the returned items. In the event that the item(s) has/have been received, in 836 an indication is provided to cancel the lease agreement. In the event that the item(s) has/have not been received, in 838 it is determined whether it is within a lookup period. In the event that it is within the lookup period control returns to 834. In the event that it is not within the lookup period, in 840 the return is canceled.

In the example shown in FIG. 8C, in the event that it is determined that the return is a partial return, in 844 it is determined whether item(s) has/have been received. For example, a list of the returned items is received. In some embodiments, the items received are checked to determine whether the items received are in good condition before canceling/adjusting the lease. In the event that the items are not in good conditions, then the consumer is liable for the fair market value of the returned items. In the event that the item(s) has/have been received, in 846 an indication is provided to adjust the lease agreement. In the event that the item(s) has/have not been received, in 842 it is determined whether it is within a lookup period. In the event that it is within a lookup period, then control passes to 844. In the event that it is not within a lookup period, then in 840 the return is canceled.

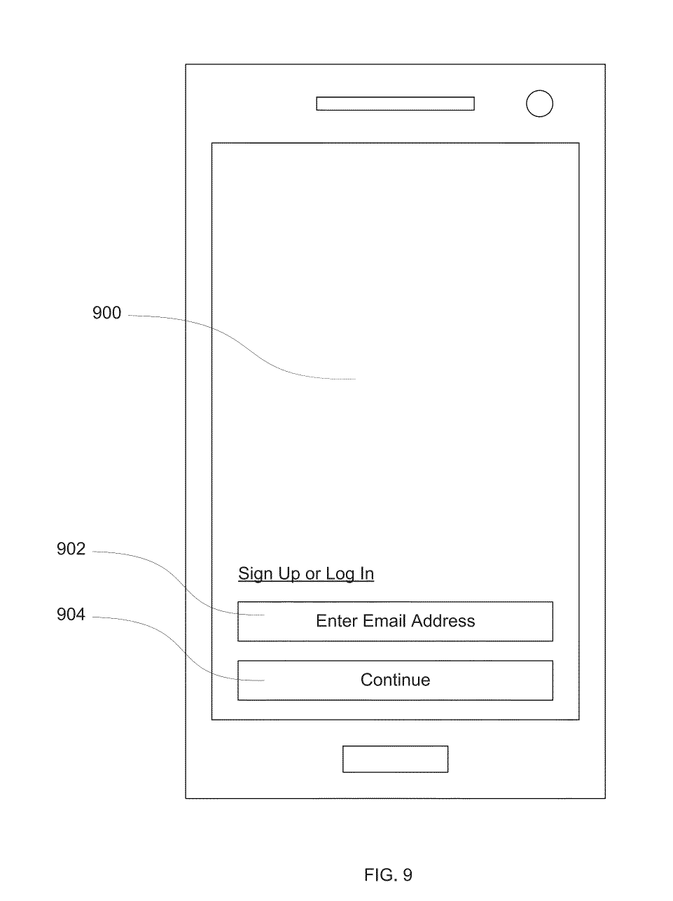

FIG. 9 is a diagram illustrating an embodiment of a mobile device display of a system for calculating payments. In the example shown, mobile application display 900 includes enter email address 902 field and continue 904 button. A user launches an application and is provided mobile application display 900 that enables a user to sign up or login to the application by entering an email address in enter email address 902 field. After the email address is entered a user can continue by pushing on continue 904 button. The user, after logging in to the application, has access to a system (e.g., an application, a server system, etc.) that enables a user to enter into a lease for merchandise.

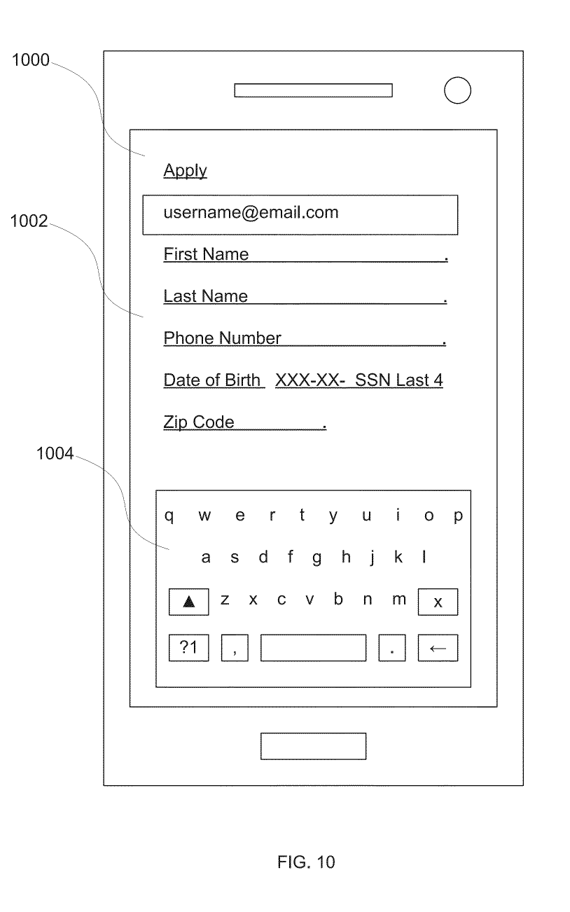

FIG. 10 is a diagram illustrating an embodiment of a mobile device display of a system for calculating payments. In the example shown, mobile application display 1000 includes text entry fields 1002 and keypad entry display 1004. A user enters a minimal set of information—for example, a first name, last name, phone number, date of birth, the last 4 social security numbers, and zip code associated with the email address (e.g., username@email.com). The minimal set of information is used by the system to determine a user identity and then to determine an authorized lease amount based on the user identity.

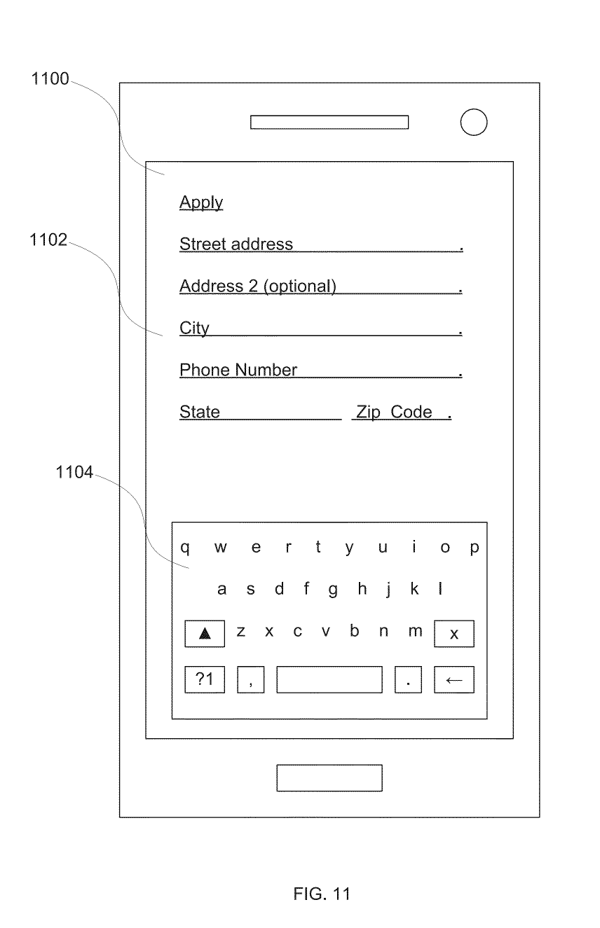

FIG. 11 is a diagram illustrating an embodiment of a mobile device display of a system for calculating payments. In some embodiments, this display is shown only to a user whose identity is not able to be identified with a minimal set of information. In the example shown, mobile application display 1100 includes text entry fields 1102 and keypad entry display 1104. A user enters an additional set of information—for example, a physical or mailing address associated with the email address. In some embodiments, the mailing address is added to a user's account after a user identity is verified. In various embodiments, the additional set of information includes a full social security number, an income amount, a pay date, a pay frequency, or any other appropriate information. The full set of information is used by the system to determine a user identity and then to determine an authorized lease amount based on the user identity.

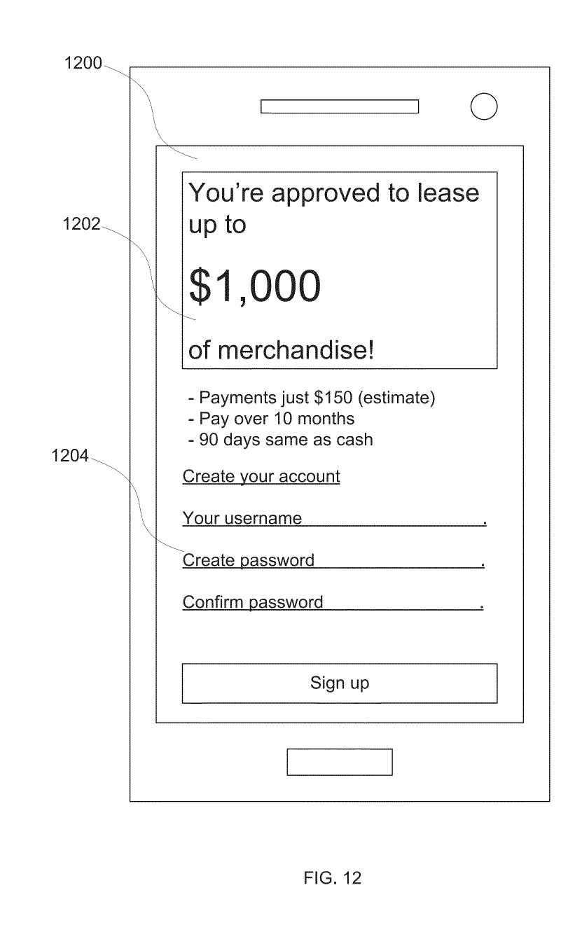

FIG. 12 is a diagram illustrating an embodiment of a mobile device display of a system for calculating payments. In the example shown, mobile application display 1200 includes approval or rejection display field 1202 and entry fields 1204. A user is provided with a lease approval showing the maximum value of merchandise that a user can lease with an estimate for payment amount or a rejection indication. In the event that the user decides to take action regarding the lease offer. The user can create an account by entering a username and create and confirm a password. In some embodiments, a user already has an account and can login to the existing account.

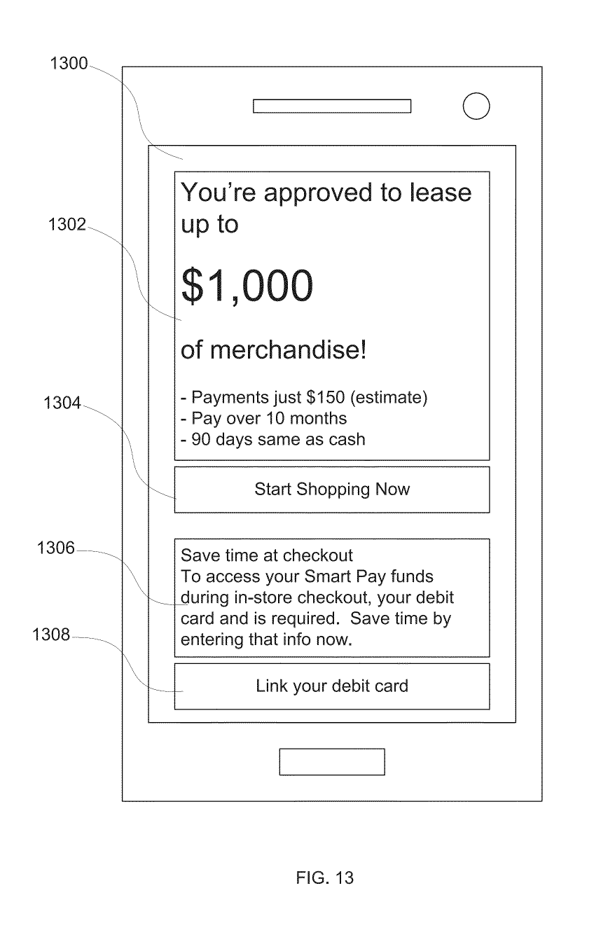

FIG. 13 is a diagram illustrating an embodiment of a mobile device display of a system for calculating payments. In the example shown, mobile application display 1300 includes approval display field 1302 and payment entry display 1306. A user is provided with a lease approval showing the maximum value of merchandise that the user can lease with an estimate for payment amount or a rejection indication. The user can start shopping (e.g., in store browsing or on-line browsing) by selecting button 1304. To save time at check out, the user can enter a payment method by selecting link 1308 (e.g., a debit card is entered to pay for an initial payment for a lease). In some embodiments, a user is able to edit or select a pay date and pay frequency. In some embodiments, the schedule defaults to the 15^{th} or 30^{th} of each month and the user is able to edit or select a different schedule. In the event that a user edits or selects payment amounts are determined that match the date/frequencies for payment that a user has selected.

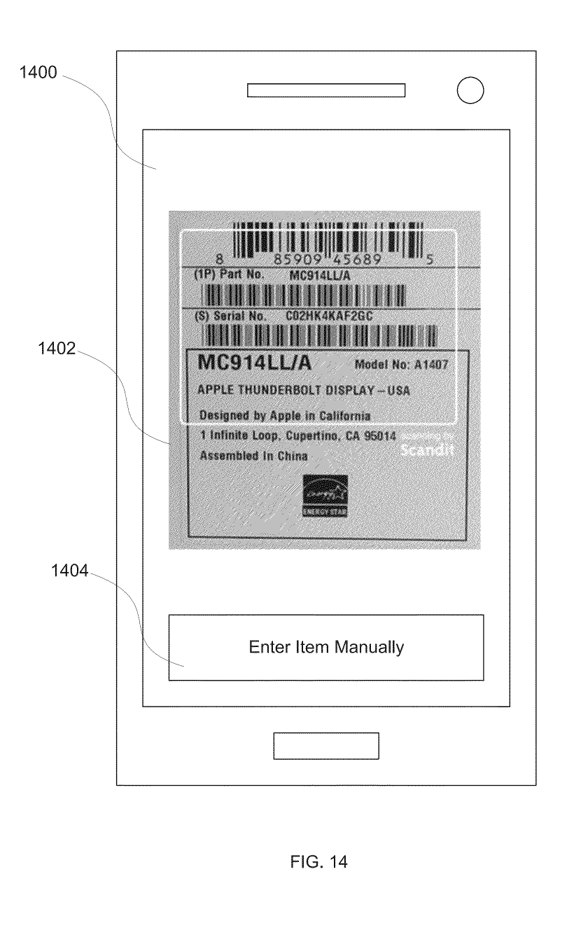

FIG. 14 is a diagram illustrating an embodiment of a mobile device display of a system for calculating payments. In the example shown, mobile application display 1400 includes image entry display 1402 and manual entry button 1404. A user starts shopping to use their approved lease amount by selecting one or more items to lease in a store using a photograph of a merchandise label. In various embodiments, the label includes a part number, a serial number, a model number, a description, a manufacturer, a SKU number, or any other appropriate information. The information is used for generating a lease agreement that includes identifying information for the leased items (e.g., a serial number and a description of the merchandise). In some embodiments, a SKU number or other identifying information is used to look up a product description for the merchandise. Manual entry button 1404 can be selected and used to enter information about an item to be leased by the user.

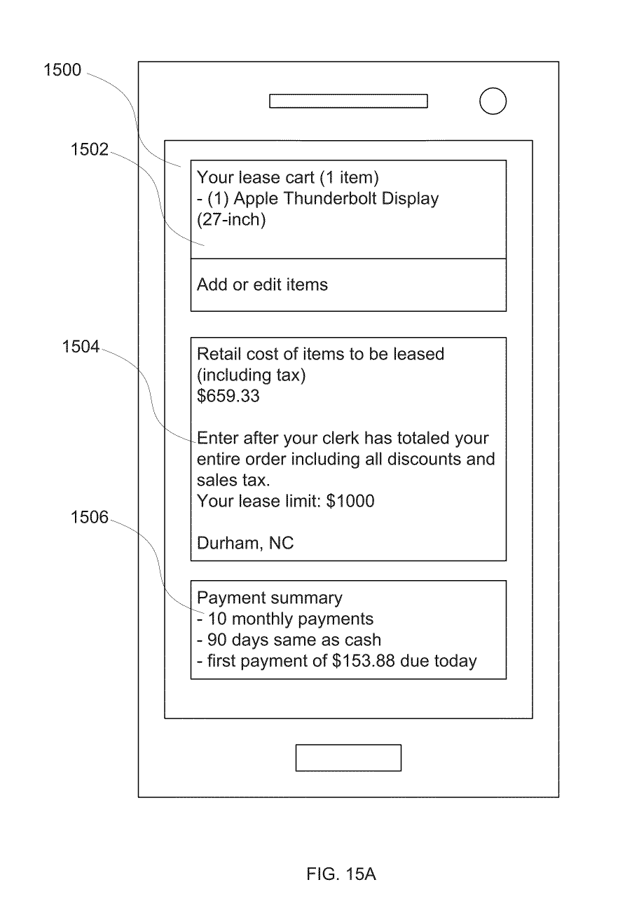

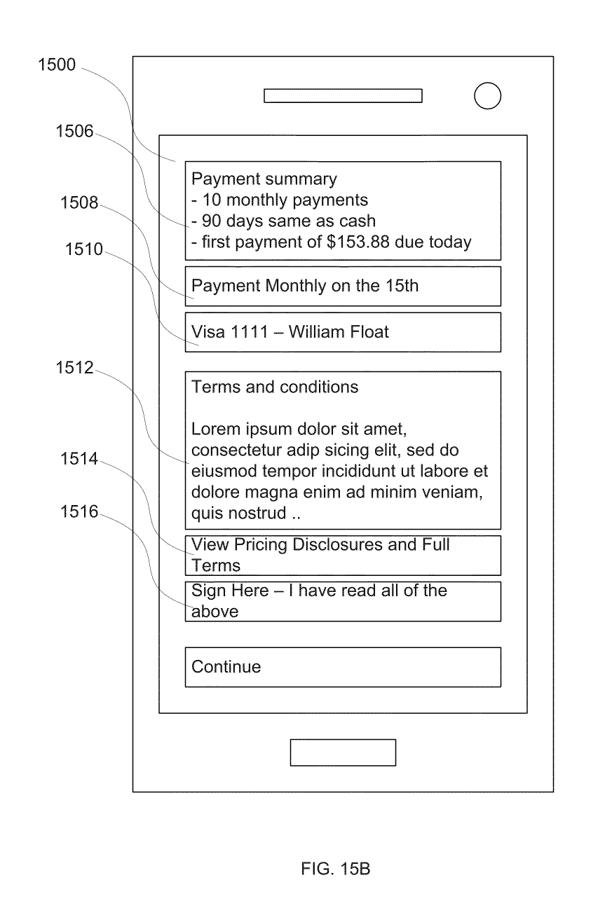

FIGS. 15A and 15B are diagrams illustrating an embodiment of a mobile device display of a system for calculating payments. In the example shown, mobile application display 1500 includes lease cart display 1502, retail cost of items to be leased entry field 1504, and payment summary display 1506. A user is provided a display that shows items in the user's cart (e.g., an apple thunderbolt display in cart display 1502) whose total is input by the user (e.g., $659.33 in retail cost of items to be leased entry field 1504). The system then displays the number of payments and the payment amount (e.g., 10 month payments where the first payment is $153.88 due today and where the first 90 days are the same as cash-no lease cost for 90 days in payment summary display 1506). The system displays a payment date 1510 (e.g., payment monthly on the 15^{th}). The system displays a payment method (e.g., a debit or credit card—for example, Visa 1111 (e.g., last 4 digits of the credit card), and credit card name, William Float). The system displays terms and conditions 1512. The system displays pricing disclosures and full terms button 1514 that enables a user to display pricing disclosures and the full terms of the lease agreement. The system displays a sign here button 1516 that requires a user to sign before continuing (e.g., the user signs that they have read all of the above).

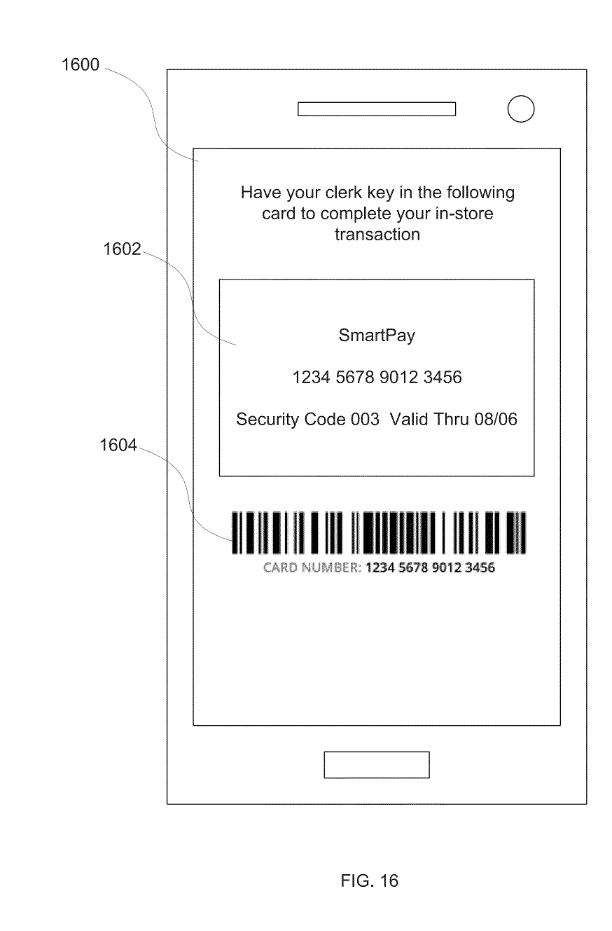

FIG. 16 is a diagram illustrating an embodiment of a mobile device display of a system for calculating payments. In the example shown, mobile application display 1600 includes virtual payment card display 1602 and virtual payment card bar code 1604. A user is provided a display that shows virtual payment card information including virtual payment card number, security code, expiration, and billing zip code. In some embodiments, the system then displays the number of payments and the payment amount (e.g., 10 month payments where the first payment is $153.88 due today and where the first 90 days are the same as cash cost shown in payment summary display 1506). The virtual payment card is presented by the user as payment information for purchasing the merchandise at a retail location or on-line store. In some embodiments, the expiration date is the last date for return of any merchandise to the original retailer in exchange for a cancellation of the lease. In some embodiments, the expiration date is based at least in part on the merchandise being purchased by the lessor on the date of the application for the lease. In some embodiments, the virtual payment card is presented to the retailer electronically over the Internet by the lessor, rather than by the user. In some embodiments, the merchandise is able to be returned to the lessor at anytime.

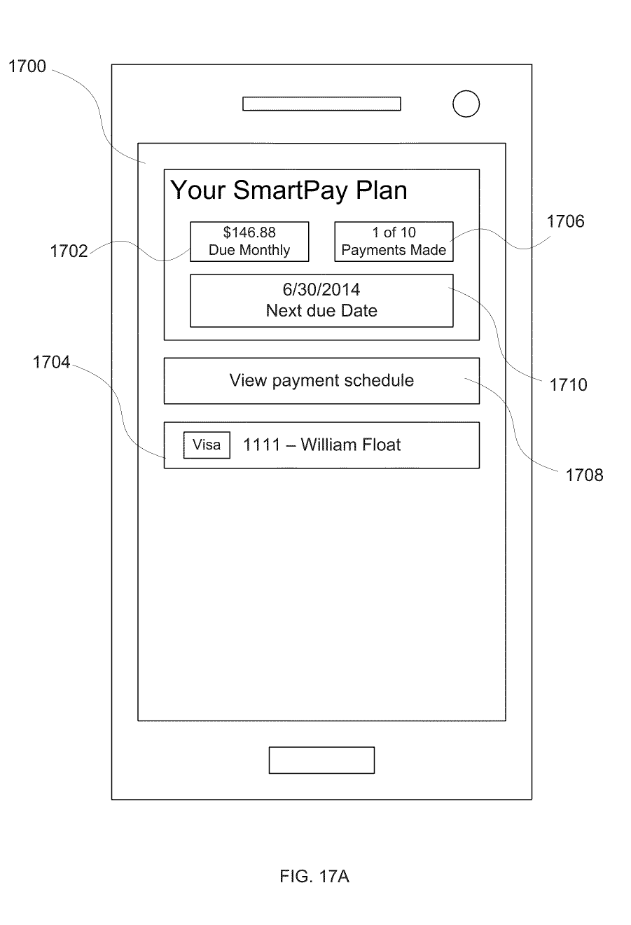

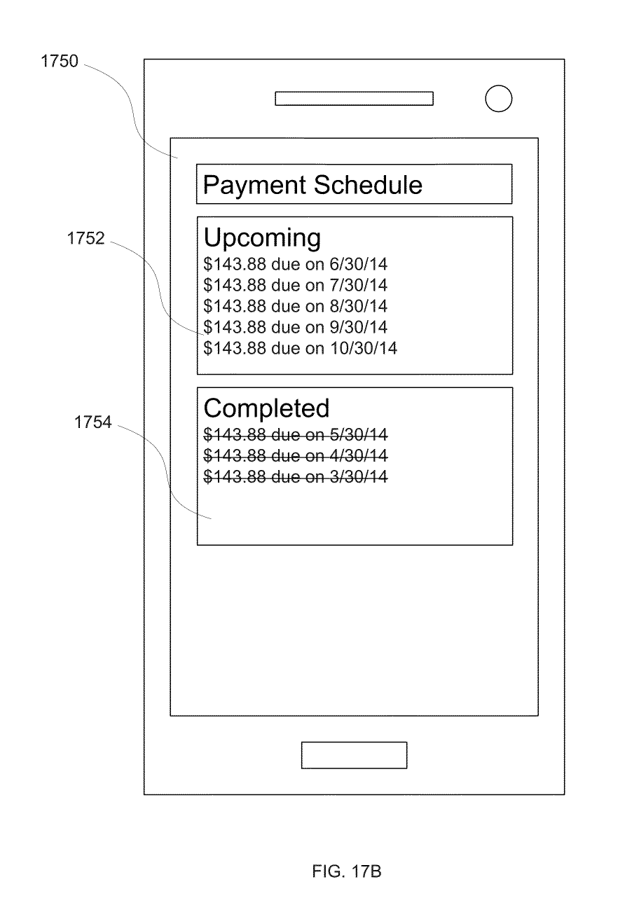

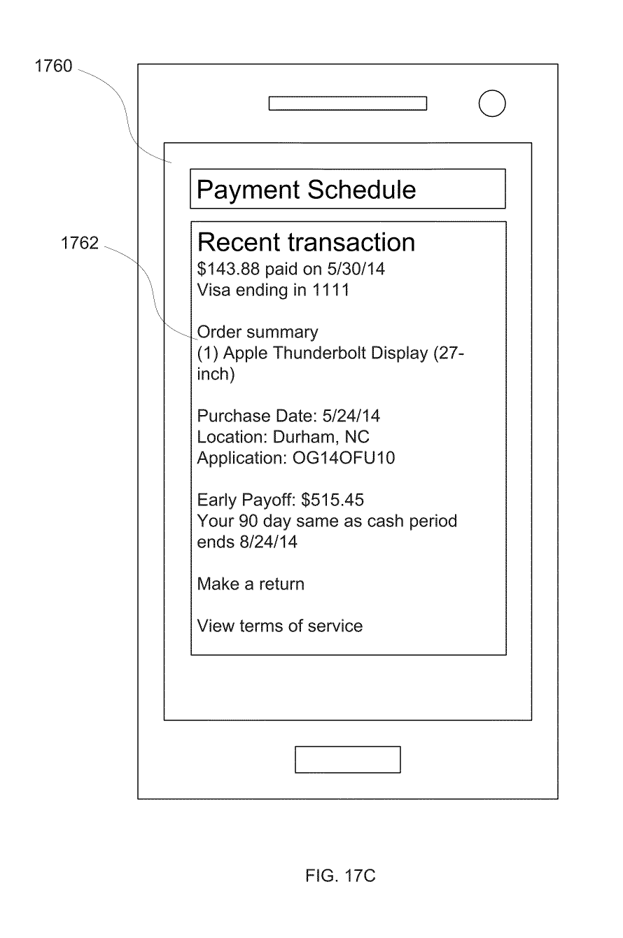

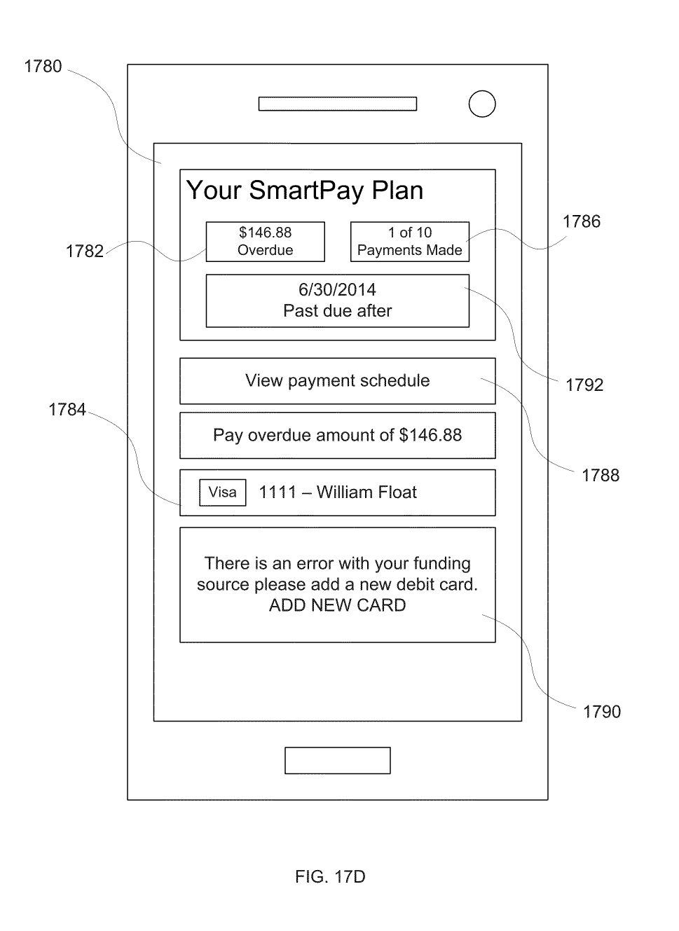

FIG. 17A is a diagram illustrating an embodiment of a mobile device display of a system for calculating payments. In the example shown, mobile application display 1700 includes payment display and payment card 1704. A user is provided a display that shows payment information including payment amount, payment or renewal date, number of payments, debit card reference. The system displays payment amount 1702 (e.g., $143.88), a due date 1710 (e.g., Jun. 30, 2014), a number of payments completed 1706 (e.g., 1 out of 10), and a view payment schedule button 1708 (e.g., 30^{th} of every month, and a debit card reference (e.g., visa debit card with last digits 1111 and associated name—William Float).

FIG. 17B is a diagram illustrating an embodiment of a mobile device display of a system for calculating payments. In the example shown, mobile application display 1750 includes upcoming payments 1752 and complete payments 1754. Upcoming payments 1752 shows payment amounts and due dates of upcoming payments. Completed payments 1754 shows payment amounts and due dates of completed payments.

FIG. 17C is a diagram illustrating an embodiment of a mobile device display of a system for calculating payments. In the example shown, mobile application display 1762 includes last paid information (e.g., amount and date, etc.), payment information (e.g., card number), order summary (e.g., product information), order specifics (e.g., purchase date, location of purchase, application identifier), early payoff information (e.g., payoff amount, time period for pay off amount, etc.), make a return button, and view terms of service button.

FIG. 17D is a diagram illustrating an embodiment of a mobile device display of a system for calculating payments. In the example shown, mobile application display 1780 includes payment display and payment card 1784. In some embodiments, a user is provided a display that shows payment information including payment overdue amount, payment or renewal date, number of payments, debit card reference. The system displays payment overdue amount 1782 (e.g., $143.88), a past due date 1792 (e.g., Jun. 30, 2014), a number of payments completed 1786 (e.g., 1 out of 10), a payment card 1784 (e.g., visa debit card with last digits 1111 and associated name—William Float), a view payment schedule 1788, and a add new card 1790 (e.g., there is an error with your funding source—please add a new debit card button).

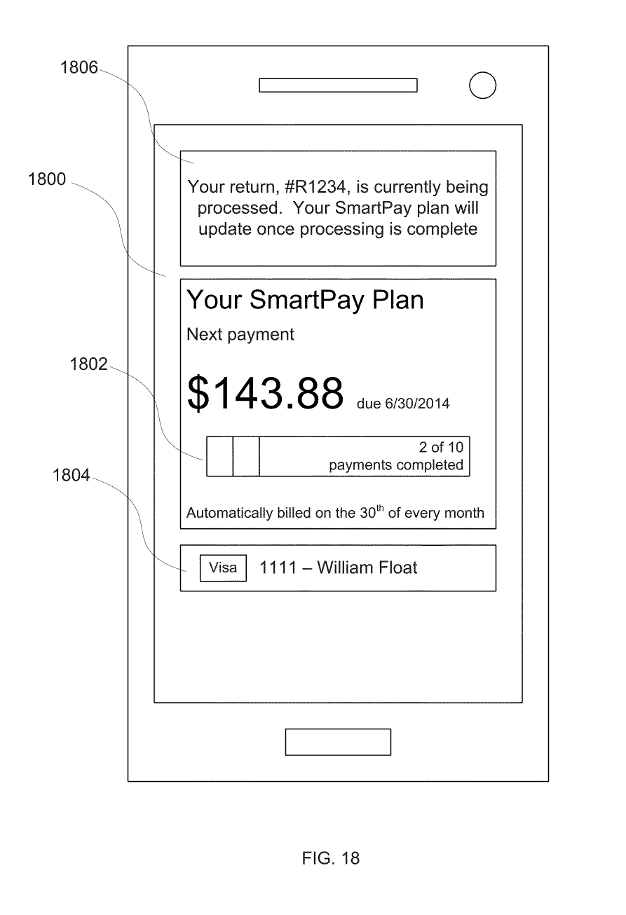

FIG. 18 is a diagram illustrating an embodiment of a mobile device display of a system for calculating payments. In the example shown, mobile application display 1800 includes payment display 1802, payment card 1804, and return display 1806. A user is provided a display that shows payment information including payment amount, payment or renewal date, number of payments, debit card reference. The system displays payment amount (e.g., $143.88), a due date (e.g., Jun. 30, 2014), a number of payments completed (e.g., 2 out of 10), a billing date (e.g., 30^{th} of every month, and a debit card reference (e.g., visa debit card with last digits 1111 and associated name—William Float). Return display 1806 indicates that the requested return is being processed and that the lease (e.g., a SmartPay plan) will be updated once the processing is complete.

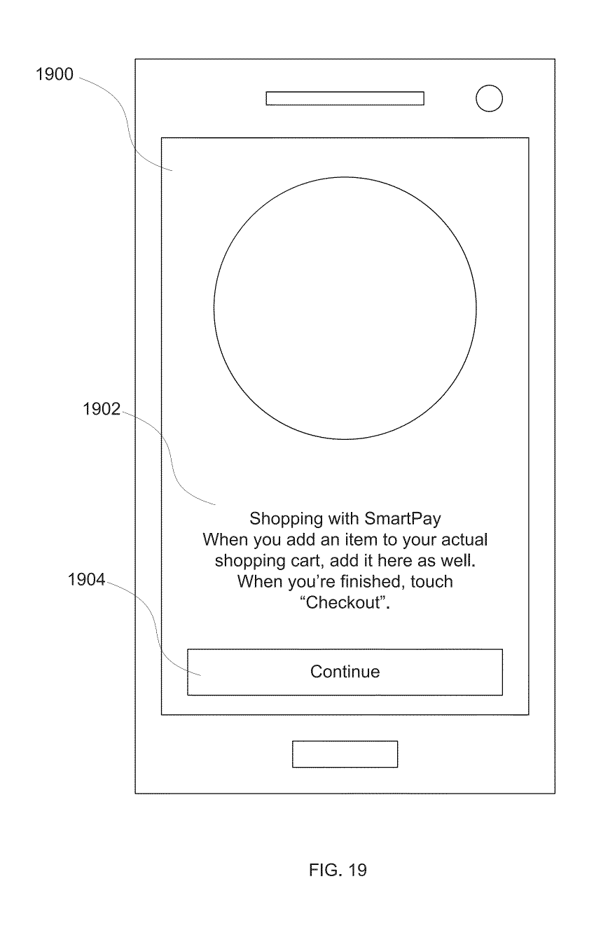

FIG. 19 is a diagram illustrating an embodiment of a mobile device display of a system for calculating payments. In the example shown, mobile application display 1900 includes text display 1902 and continue button 1904. A user is provided a text display that indicates to add item to a shopping cart of the application on a mobile device when an item is added to an actual physical shopping cart in a physical retail store or when shopping on-line.

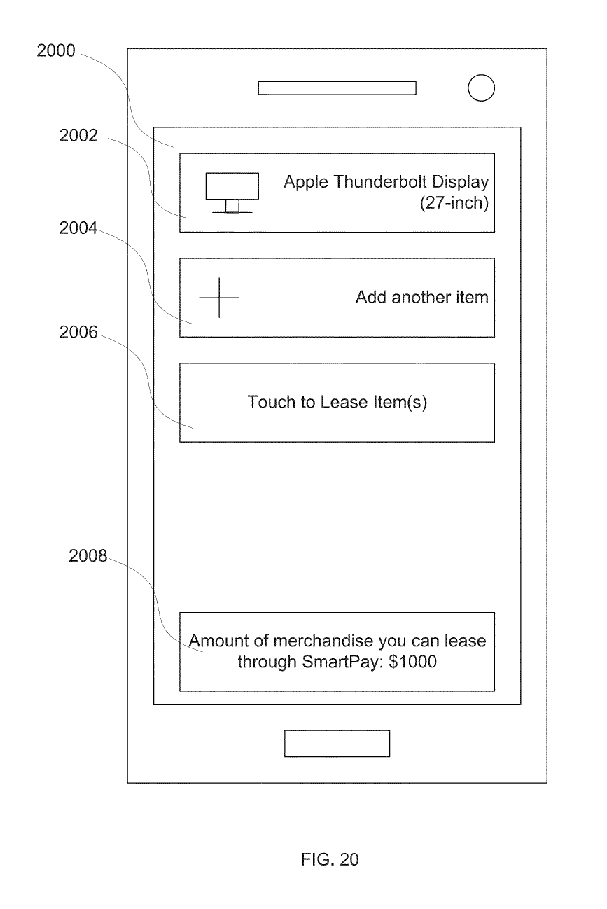

FIG. 20 is a diagram illustrating an embodiment of a mobile device display of a system for calculating payments. In some embodiments, the display is associated with a parallel cart that has a digital representation of what is present in an online cart at an online retailer or physical cart at a brick and mortar retailer. In the example shown, mobile application display 2000 includes item display 2002, add item button 2004, touch to lease item(s) button 2006, and amount of merchandise that can be leased display 2008. A user is provided a display of a parallel cart to an online cart. Each item is added in the parallel cart to prepare for checkout. Parallel checkout provides the application the information for the lease system. In some embodiments, the item information is gathered by scraping an online store or using an API from the online website instead of manually entering the item(s) to be leased in display 2006.

In some embodiments, upon adding an item to lease, a database is checked to determine an estimated retail value of the leased items in real time. The value entered by a user at the point of checkout and the estimated retail value of the combined items is compared. In the event that a discrepancy between the two is too large, the system may cancel the transaction or require the user to enter accurate information. This protects the lessor from fraud and ensures that any loans secured by the leased items are properly collateralized.

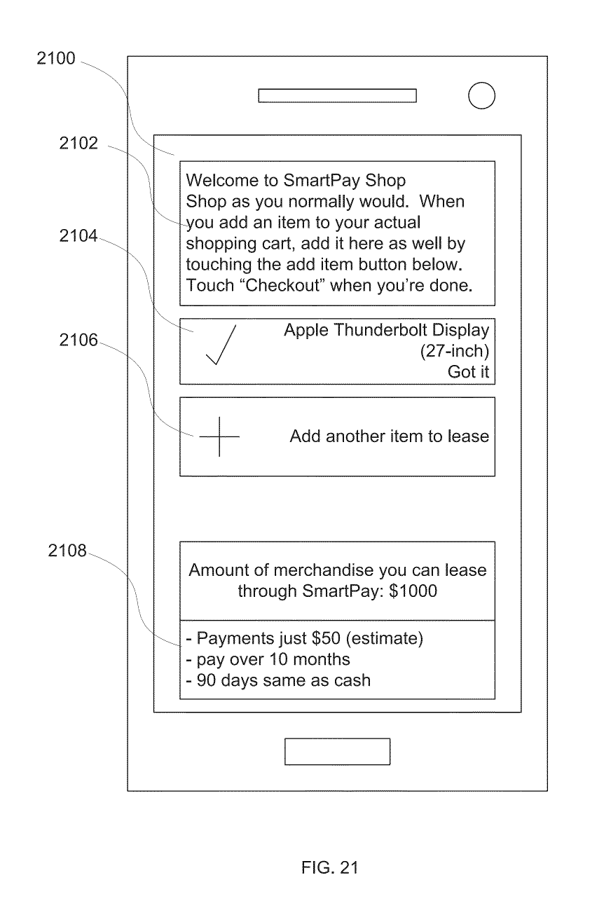

FIG. 21 is a diagram illustrating an embodiment of a mobile device display of a system for calculating payments. In some embodiments, the display is associated with a parallel cart that has a digital description of what merchandise is present in a physical cart at a physical retailer. In the example shown, mobile application display 2100 includes text display 2102, got it display 2104, add another item to lease button 2106, and amount of merchandise the user can lease through SmartPay and payment display 2108. A user is a display of a parallel cart to an in-store physical cart. Each item is added in the parallel cart to prepare for checkout. Parallel checkout provides the application the information for the lease system. The information is used to generate lease information and payment information (e.g., a virtual card).

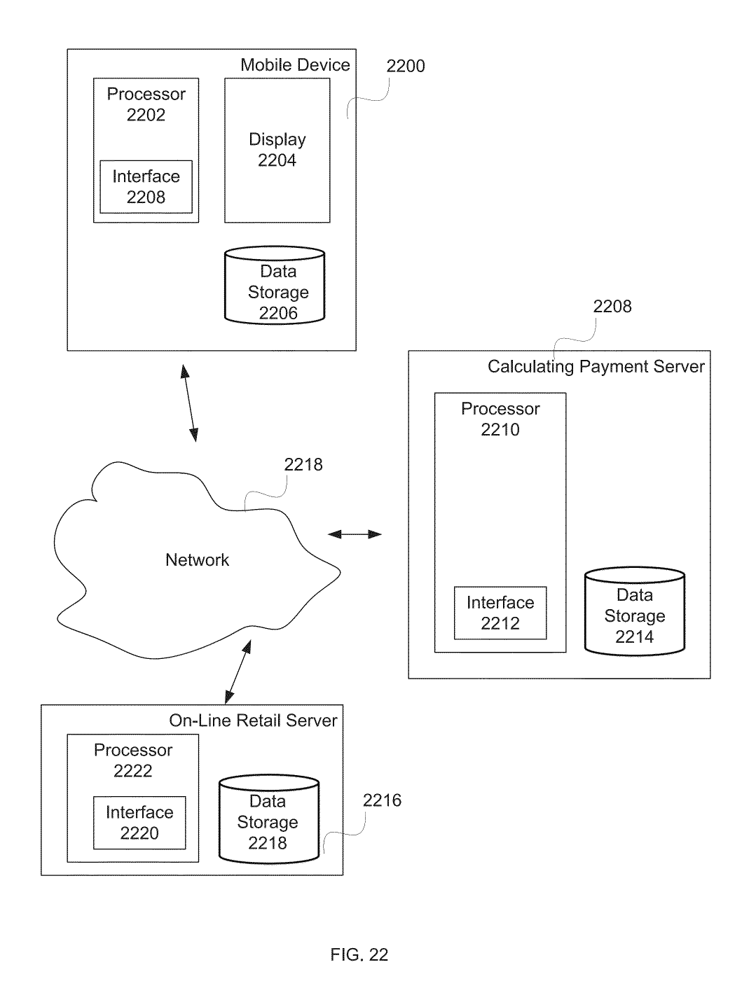

FIG. 22 is a block diagram illustrating an embodiment of a system for calculating payments. In the example shown, calculating payment server 2208 is accessed by a user from mobile device 2200. The user is enabled to lease merchandise using a payment enabled by calculating payment server 2208. The payment enabled is a result of an auto-generated lease agreement assumed by the user whereby the user agrees to pay a lease price (e.g., merchandise price, merchandise tax, lease fee, lease tax, etc. as a series of payments) to acquire use of the merchandise. Mobile device 2200 includes display 2204, processor 2202, interface 2208, and data storage 2206. Calculating payment server includes processor 2210, interface 2212, and data storage 2214. In some embodiments, calculating payment server 2208 includes a pricing engine that takes case of all calculations and a legal document generator that generates compliant legal agreements. Mobile device 2200 communicates with calculating payment server 2208 via network 2218. In various embodiments, network comprises a wired network, a wireless network, a local area network, a wide area network, the internet, or any other appropriate network or combination of networks. In some embodiments, user is shopping at an online retailer (e.g., accessing on-line retail server 2216 which includes processor 2222, interface 2220, and data storage 2218 from within a webview window running within a mobile device application that is associated with the calculating payment system).

In some embodiments, a user inputs information to mobile device 2200 to apply for a lease (e.g., a minimal set of information). The information is used to identify the user and to enable an automatic assessment of an amount to lease (e.g., perform, a credit assessment, an identity assessment, etc.) and determine a lease maximum amount. In some embodiments, the lease maximum amount and terms are influenced based on data collected automatically from the mobile device, such as location and type of mobile device. In some embodiments, the maximum merchandise value to be leased and lease terms are influenced by the information sent from the mobile device to the processor and the processor's cross-referencing of this information with other databases and information, such as assessing local resale values for the merchandise in the area where the mobile device is located. In some embodiments, third party servers are queried for identity information and credit information. The user can then shop for merchandise (e.g., equipment) either in a retail store or an on-line retail site. The information for the merchandise is determined based on partial input facilitated by a user (e.g., photo of serial number, merchandise SKU, web page information, etc.). Databases are accessed (e.g., as stored in data storage 2214, data storage 2218, etc.) to provide detailed information regarding the merchandise to auto generate a lease agreement (e.g., serial number, merchandise description, etc.). A determination of the applicable tax laws, disclosure requirements, or other requirements are determined based on location of mobile device 2200 or retailer or on-line retail server. This information is also used to help in the auto generation of the lease agreement. Calculating payment server 2208 further provides payment information (e.g., a virtual payment card) to enable lessor to pay at the retail site or on-line retailer for the merchandise to be leased to the user. The user agrees to the lease and has payments automatically deducted from a provided payment method (e.g., using a debit card) periodically. The payments are automatically calculated by determining a cost of merchandise (e.g., by removing tax cost form total cost, where tax has been determined using a location), the location of the merchandise, the likely resale value of the merchandise, the likely useful life of the merchandise, and reports of customer satisfaction with the merchandise to determine lease payments and lease tax (e.g., using a location information to determine lease tax), determining return adjustments to lease payments and lease tax, or any other appropriate calculation and/or determination.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for automatic determination of eligibility, payments and tax for a merchandise lease, comprising:
an interface configured to:
receive a minimal set of information; and
a processor configured to:
determine that it is possible to determine a full identity using the minimal set of information;
determine a maximum lease amount based at least in part on the full identity; and
determine one or more lease payments and lease tax based at least in part on a merchandise price and a location tax rate.

2. A system as in claim 1, wherein the minimal set of information comprises a name, a date of birth, zip code and a last for social security numbers.

3. A system as in claim 1, wherein the processor is configured to, in the event it is not possible to determine the full identity, provide request for additional information.

4. A system as in claim 3, wherein the addition information comprises a full social security number.

5. A system as in claim 1, wherein the processor is configured to verify the full identity.

6. A system as in claim 1, wherein the interface is configured to receive an identifier for a merchandise item.

7. A system as in claim 6, wherein the processor is configured to determine a description of the merchandise item using the identifier.

8. A system as in claim 7, wherein the processor is configured to store the description of the merchandise.

9. A system as in claim 1, wherein the interface is configured to receive a geolocation information.

10. A system as in claim 9, wherein a state and the location tax rate is determined based at least in part on the geolocation information.

11. A system as in claim 10, wherein the processor is configured to determine the merchandise price for the merchandise using a total purchase amount and the location tax rate.

12. A system as in claim 1, wherein the processor is configured to cause the generation of a virtual card.

13. A system as in claim 12, wherein the virtual card is able to be used to purchase the merchandise.

14. A system as in claim 1, wherein the interface is configured to receive a request for a return.

15. A system as in claim 14, wherein the processor is configured to determine whether the return is a complete or partial return.

16. A system as in claim 15, wherein the processor is configured to, in the event that the return is not a full return, determine a revised lease payment and a revised lease tax.

17. A method for automatic determination of eligibility, payments and tax for merchandise lease, comprising:
receiving a minimal set of information;
determining, using a processor, that it is possible to reconstruct a full identity using the minimal set of information;
determining a maximum lease amount based at least in part on the full identity; and
determining one or more lease payments and lease tax based at least in part on a merchandise price and a location tax rate.

18. A computer program product for automatic determination of payments and tax for merchandise lease, the computer program product being embodied in a tangible computer readable storage medium and comprising computer instructions for:
receiving a minimal set of information;
determining, using a processor, that it is possible to reconstruct a full identity using the minimal set of information;
determining a maximum lease amount based at least in part on the full identity; and
determining one or more lease payments and lease tax based at least in part on a merchandise price and a location tax rate.
